(19) United States
(12) Patent Application Publication
(10) Pub. No.: US 2023/0191764 A1
(43) Pub. Date: Jun. 22, 2023

(54) TRANSPARENT, POLYESTER FILM WITH SMOOTH SURFACE ON ONE SIDE AND COMPRISING POLYMETHYLSILSESQUIOXANE-BASED PARTICLES

(71) Applicant: Mitsubishi Polyester Film GmbH, Wiesbaden (DE)

(72) Inventors: Miriam HUMMEL, Rüdesheim (DE); Dagmar KLEIN, Ockenheim (DE); Holger KLIESCH, Ginsheim-Gustavsburg (DE); Artur MICHALSKI, Gau-Algesheim (DE); Bodo KUHMANN, Runkel (DE)

(73) Assignee: Mitsubishi Polyester Film GmbH, Wiesbaden (DE)

(21) Appl. No.: 18/085,989

(22) Filed: Dec. 21, 2022

(30) Foreign Application Priority Data
Dec. 22, 2021 (DE) 10 2021 134 261.9

(51) Int. Cl. B32B 27/36; B32B 37/15; B32B 38/00; B32B 38/18; B32B 27/20; B32B 7/03

(52) U.S. Cl. CPC B32B 27/36; B32B 37/15; B32B 38/0036; B32B 38/1816; B32B 27/20; B32B 7/03; B32B 2250/03; B32B 2250/24; B32B 2264/1022; B32B 2307/412; B32B 2264/302; B32B 2264/0214; B32B 2264/12; B32B 2307/518

(57) ABSTRACT

An at least three-layer biaxially oriented polyester film is provided that includes a layer B, a rough outer layer A and a smooth outer layer C, with the outer layers A and C each being external layers arranged on the opposite surfaces of the base layer B. The outer layer A includes polymethylsilsesquioxane-based particles, the outer layer C includes less than 0.1% by weight of particles different from the polymethylsilsesquioxane-based particles. The polyester film contains no 2,6-naphthalenedicarboxylic-acid-derived units as repeat unit, and the film includes less than 0.1% by weight of particles. The polyesters in the outer layers comprise isophthalic acid-derived repeat units in an amount of <19% by weight. The invention further relates to a process for to produce the film and to its use as process film for the transfer of surface properties, especially for furniture surfaces.

### CROSS-REFERENCE TO RELATED APPLICATIONS

This application claims priority to German Patent Application No. 10 2021 134 261.9, filed Dec. 22, 2021. Parent German Patent Application No. 10 2021 134 261.9 is hereby incorporated herein in its entirety.

### FIELD OF THE INVENTION

Biaxially oriented, at least three-layer, polyester film that is smooth on one side and has at least one particle-containing external layer, process for the production thereof, and use thereof as process film for the transfer of surface properties, especially for furniture surfaces.

The present invention relates to a biaxially oriented polyester film that is smooth on one side and has high transparency, low haze and, opposite to the smooth side, an external layer comprising polymethylsilsesquioxane-based particles as process auxiliary with a total thickness of 12-90 μm. The film of the invention has excellent suitability for transferring a smooth, high-gloss surface to lacquers, as desired for furniture surfaces in particular. The smooth side is here substantially particle-free. The particle system on the reverse side is sufficiently well incorporated and of a chosen size and shape such that when using the film no particle abrasion occurs that would cause damage to the smooth side from abraded material during winding and characterized in that the particles do not press into the opposite, smooth side to an extent that causes impairment.

### BACKGROUND OF THE INVENTION

For many applications, particularly lacquers in the furniture sector but the surfaces of other plastics too, for example PU mouldings, a particularly smooth, high-gloss surface is desirable for design reasons. However, surface unevennesses often develop in these lacquers or plastics during application, consequently a smooth template is in practice frequently used that transfers its surface to the lacquer or moulding. An example of a suitable template is a polyester film, which must be very smooth at least on one side in order to ensure a particularly flat and uniform surface with high gloss.

However, such films expediently comprise, opposite to the smooth side, a rougher surface that permits/facilitates the transport of the film in the production process and its handling during subsequent processing. Two pigment-free surfaces would moreover stick to one another on the wound roll and then sometimes be impossible to unwind without surface damage.

Films having a smooth surface on one side are known in the prior art. For example, EP-A-1 410 905 describes a multilayer polyester film that has a particle-free surface. EP-A-1 410 905 describes the use of silicon dioxide particles having a particle size of up to 4.0 μm in the rough side. Silicon dioxide particles are hard and pressure results in surface deformation, which occurs on the opposite, smooth side too if the distance between the particle-containing layer boundary and the upper side of the smooth layer on the outside of the film is less than 8 μm. Moreover, during winding of the film these hard particles press into the smooth layer, causing depressions in said smooth layer. Such particles cause visible damage to the lacquer to be transferred.

EP-A-1 884 357 likewise describes a polyester film that is smooth on one side, has a particle-free surface, and on the opposite surface comprises as process aid an incompatible polymer that provides the desired surface roughness, but also renders the film highly opaque. The substantial opacity impacts on the usability of the film in the end use, specifically the curing of the lacquer using light, for example UV curing, is made much more difficult and process control through the film prior to removal becomes impossible.

EP-A-3178651 likewise describes a polyester film that is smooth on one side, has an almost particle-free surface, and on the opposite surface comprises as process aid calcium carbonate particles. These have considerable advantages compared to SiO2 particles as described in EP-A-1 410 905 and cause much less damage to the smooth side during winding. Pure calcium carbonate is however relatively poorly incorporated into the polyester matrix, giving rise when cutting the film and during winding or unwinding to abraded material that can adhere to the surface of the film and can then cause indentations in the smooth surface during winding, which would result in scratches. EP-A-3178651 also describes, as an alternative, the use of a special surface-treated calcium carbonate (vaterite) that significantly reduces the abrasion problem, but the special method of precipitation and the surface treatment as laborious additional process steps make this a very costly particle system. Moreover, the surface treatment composition containing fats and polymeric carboxylic acids has a tendency for fatty acids in particular to migrate onto the film surface; these then undergo contact-mediated transfer to the smooth film surface during winding and can adversely affect the separating properties of the smooth surface (especially its evenness.

### SUMMARY OF ADVANTAGEOUS EMBODIMENTS OF THE INVENTION

It was therefore an object of the present invention to provide a biaxially oriented polyester film that is smooth on one side and ensures economic further processing and also lower opacification of the film. In addition, the smooth side of the film must not be disadvantageously damaged by indentations, not have a tendency to particle abrasion, and the film must not contain any migrating substances with an adverse effect on separating properties.

### DETAILED DESCRIPTION OF ADVANTAGEOUS EMBODIMENTS OF THE INVENTION

This object is achieved by an at least three-layer biaxially oriented polyester film comprising at least a base layer B, a rough outer layer A and a smooth outer layer C, wherein the outer layers A and C are each external layers and arranged on the opposite surfaces of the base layer B, wherein the outer layer A comprises polymethylsilsesquioxane-based particles, the outer layer C comprises less than 0.1% by weight of particles (the percentages by weight being based on the mass of the respective layer) and wherein the film overall comprises less than 0.1% by weight (based on the mass of the film overall) of particles, and wherein the polyesters used for production of the outer layers of the film comprise isophthalic acid-derived repeat units in an amount of <19% by weight (based on the mass of the respective outer layer).

Such a film has the following properties:
transparency of 85 to 97%
haze of <7%
a total film thickness of 12-90 μm
a smooth outer layer C having the roughness values Sa<10 nm, Sp<100 nm, Sv<100 nm, and a total number of particles of <20, measured according to ISO 25178-2
a smooth outer layer C that comprises less than 0.1% by weight of particles
a smooth outer layer C having a thickness of at least 2 μm
a rough outer layer A having the roughness values Sa≥11 nm, Sp≥120 nm, Sv≥120
where the rough outer layer A comprises polymethylsilsesquioxane-based particles having an average size d₅₀ of 0.5 μm to 1.5 μm and a particle content of 0.1% to 0.7% by weight.

The total film thickness is at least 12 μm and at most 90 μm. The film thickness is preferably at least 23 μm and at most 80 μm, and ideally at least 35 μm and at most 76 μm. If the film thickness is less than 12 μm, the stiffness is insufficient to permit even application to the surface and to ensure even transfer of the lacquer to the underlying substrate. With increasing thickness, the quality of the lacquer undergoing transfer tends to improve from 12 to about 35 μm. Above 90 μm the film becomes too stiff, and no longer achieves adequate contact with the substrate. Moreover, the price per unit area rises with increasing thickness, making the use of the film less economic. Increasing thickness is however also accompanied by better processability in subsequent lacquer transfer processes, since the risk of the film tearing, wrinkling or undergoing local deformation is significantly reduced. Furthermore, with a higher film thickness, the particle-free outer layer can also be economically produced with a greater thickness, since conventional units for producing three-layer polyester films achieve optimal area output when the outer layer accounts for about 10% of the total thickness. The film therefore achieves optimum economic usability in the thickness range between 35 and 76 μm.

The film has at least three layers, including a smooth outer layer C and an opposite outer layer A comprising polymethylsilsesquioxane-based particles. Between these layers there is at least one base layer and optionally further intermediate layers.

A structure having only two layers without the base layer is not possible, because then either the particle-containing layer would have to be too thick, with resulting poor optical properties (transparency, haze), or the smooth layer would be too thick, which would make it impossible to achieve economic recycling of regrind material to the particle-containing layer.

The base layer accounts for a proportion of at least 60%, preferably at least 70% and more preferably at least 80%, of the total film thickness. This facilitates economic recycling of the regrind material that arises.

The particle-containing outer layer A has a thickness of preferably at least 0.8 μm and at most 3.7 μm, particularly preferably 1.0 μm to 3.5 μm and very particularly preferably 1.4 μm to 3.0 μm. Below 0.8 μm an adequately good winding result can be achieved only with difficulty with the particle contents described as suitable hereinbelow. The amount of pigment may then be insufficient. Above 3.5 μm no further improvement in the winding result is achieved by increasing the thickness and the introduction of particles (including introduction of more particles via the regrind material that arises) results in a film having undesirably high haze and low transparency.

The thickness of the smooth, substantially particle-free outer layer C is preferably at least 2 μm, particularly preferably at least 2.5 μm, very particularly preferably at least 4.0 μm. In principle, a further increase in the thickness of the substantially particle-free layer up to 8.0 μm brings a further improvement in the surface, but thereabove no further improvement is achieved. Below 2 μm particles from the base layer (particles from the regrind material, or else catalyst precipitates and other impurities) press through the outer layer, causing undesirable elevations in the surface of outer layer C.

The regrind material that arises during film production can be supplied either to the particle-containing outer layer A or to the base layer B. It is preferable that the regrind material is supplied only to the base layer B, so that the supplied particle-containing regrind material causes only slight impairment of the surface or none at all.

If the outer layers become too thick, the economic viability decreases, since regrind material should preferably be supplied to the base layer B and, if the thickness of the base layer B is too low by comparison with the total thickness of said layers, it then becomes necessary to supply an excessive percentage of regrind material in order to close the recycling loop.

The outer layer A comprises polymethylsilsesquioxane-based particles in an amount preferably from 0.1% by weight to 0.7% by weight, particularly preferably from 0.15% by weight to 0.6% by weight and very particularly preferably from 0.2% by weight to 0.35% by weight. Below 0.1% by weight the particles are unable to provide sufficient aid to winding. Above 0.7% by weight there is the risk of formation of agglomerates, which during winding can press into the opposite, smooth layer C. Agglomerates also increase the haze of the film, which is undesirable. The median diameter (d50) of the particles is preferably from 0.5 μm to 1.5 μm, particularly preferably 0.6 μm to 1.2 μm and very particularly preferably 0.65 μm to 1.0 μm. d50 values of less than 0.5 μm result in a significantly poorer winding result, and d50 values of greater than 1.5 μm result during winding in deep indentations in the opposite, smooth layer C. The greater the particle content in % by weight, the greater also the risk of formation of individual agglomerates that are then large enough to cause indentations in the smooth layer C during winding.

It is in principle possible here to combine particles having different d₅₀ values. However, when using the particles of the invention it was surprisingly found that a narrow size distribution of all particles (ideally monodisperse) achieves a better winding result for the same total pigment content than for example a combination of larger polymethylsilsesquioxane-based particles having a d₅₀ of 1.3 μm with smaller polymethylsilsesquioxane-based particles having a d₅₀ of for example 0.7 μm.

It was therefore found to be favourable when the particle distribution is largely monodisperse below 1.5 μm and above 0.5 μm. This is the case when more than 60% of all particles in this size range are within a size interval of ±0.2 μm of the highest maximum of the particle distribution in this range.

Particles based on polyurethane have proven unsuitable. Heavily crosslinked PU particles also impart a yellow/orange coloration to the film, which increases further when regrind material is used.

Crosslinked polystyrenes (for example with divinylbenzene as crosslinker) are not sufficiently well incorporated and consequently result in increased haze, which limits the amounts that can be used, moreover the polystyrene undergoes thermal degradation, which gives rise to measurable emissions of styrene gas in the production area. Polystyrene particles are therefore less preferable for the purposes of the invention.

Polypropylene-based particles likewise exhibit poor incorporation into the polyester matrix and also impart a yellow coloration to the film and are therefore unsuitable for the purposes of the invention.

PMMA-based particles, if uncrosslinked, lead to substantial changes in the melt, which can result in a film having a poor thickness profile. As previously mentioned, uncrosslinked particles are unsuitable for the purposes of the invention. Surprisingly, even PMMA particles having varying degrees of crosslinking still had an adverse effect on the stability of the viscosity of the melt in the extruder. At low dosages, the resulting uniformity of thickness is acceptable with good process control. The higher the particle content in the pigmented layer, the more difficult it becomes to achieve a good uniformity of thickness. PMMA particles are in addition partly comminuted under the polyester extrusion conditions, resulting in particle fragments that no longer contribute sufficiently to the antislip effect, which is why more particles than are theoretically needed must initially be used. PMMA particles are therefore less suitable for the purposes of the invention.

Surprisingly, particles based on PMSQ (polymethylsilsesquioxane) have proven particularly suitable. Whereas the use of compounds similar to siloxanes would normally have been expected to result in outward migration of low-molecular-weight constituents (during winding these could then be transferred to the smooth side through contact, where they adversely affect the evenness of the lacquer layer in subsequent process steps), this did not occur when using particles based on PMSQ (polymethylsilsesquioxane). Such particles are available for example under the E+ (PMSQ) trade names from Coating Products OHZ E.K., Sachsenring 11, 27711 Osterholz-Scharmbeck, Germany.

The polymethylsilsesquioxane-based particles comprise covalently linked units of the formula CnH2n+x as part of the structure. Here n is greater than zero and preferably less than 10, more preferably less than 5 and ideally less than 4, since overly long aliphatic hydrocarbon structural elements in the polymer result in poorer incorporation into the polyester matrix. In addition, x is either 0 or 1, with 1 preferred.

The polymethylsilsesquioxane-based particles here consist of a crosslinked or partially crosslinked polymer. In other words it is solid particles and not melted incompatible polymer present in spherical form in the film.

According to the present invention it is preferable that the particles have a K value (10% compressive strength) of <32 MPa, preferably of less than 25 MPa and more preferably of <19 MPa. The K value is here preferably greater than 6 MPa, more preferably greater than 8 MPa and ideally greater than 10 MPa. A small K value results during winding in the particles themselves undergoing deformation rather than pressing into the opposite layer under the bearing pressure, which makes damage to this layer further unlikely. If the K value to too low (in particular <6 MPa), the particles already undergo deformation during winding and lose some of their surface activity, i.e. the effective roughness decreases and wrinkle-free winding of the film is no longer possible to a sufficient degree. The K value is here defined as the force required to compress the particles by 10%.

The total amount of particles (amount of polymethylsilsesquioxane-based particles plus particles different therefrom) based on the weight of the film overall is in a preferred embodiment not more than 0.1% by weight, preferably not more than 0.07% by weight and more preferably not more than 0.04% by weight. The higher the particle content, the greater the haze and the lower the transparency, with the described adverse effect on UV curing.

Uncrosslinked polymers that have a whitening effect but are incompatible with the polyester main constituent, for example polypropylene, COCs, polyethylene, polystyrene, etc., are for the purposes of the invention present to an extent of less than 0.1% by weight and are ideally absent altogether (0% by weight), since they result in a significant increase in haze and decrease in transparency.

Whitening particles such as titanium dioxide and barium sulfate are present in the film to an extent of less than 0.05% by weight, preferably less than 0.03% by weight, and are ideally absent altogether (0% by weight), since they greatly reduce transparency, especially in the UV range.

In addition to the polymethylsilsesquioxane-based particles of the invention, the film can also comprise other particles, for example calcium carbonate, silicon dioxide or aluminium trioxide, the content of such particles being preferably <0.05% by weight, more preferably <0.03% by weight and especially less than 0.01% by weight, based on the weight of the film overall. Particles other than the preferred particles reduce transparency and increase haze, in addition to which there is an increased risk of agglomerate formation and consequent indentations in the smooth side of the film.

The layer C forming the smooth side of the film preferably comprises <0.1% by weight based on layer C of intentionally added particles, more preferably <0.01% by weight and especially none at all. All particles in the layer C increase surface roughness and result in indentations in the transferred lacquer. The layer C may comprise particles that derive from the catalyst used in the production of the polyester. In order to substantially reduce the content of these particles too, preference is given to using in layer C the polymers described hereinbelow.

The polymer of the base layer B and of the other layers consists preferably to an extent of at least 90% by weight, more preferably to an extent of 95% by weight, of a thermoplastic polyester. Preference is given here to a polyester produced from ethylene glycol and terephthalic acid (=polyethylene terephthalate, PET). Polyesters comprising naphthalene-2,6-dicarboxylic acid as repeat unit are not suitable, since these lead to undesirable UV absorption. This is particularly important when the proportion of naphthalene-2,6-dicarboxylic acid derived units in the base layer is above 5 wt %. The polyester can comprise other monomers, such as isophthalic acid or cyclohexanedimethanol or ethylene glycol. The polyester used for production of the outer layers of the film comprises isophthalic acid-derived repeat units in an amount of <19% by weight (based on the mass of the respective outer layer). This means that the isophthalic acid content in the outer layers is <19% by weight, more preferably <15% by weight and especially <10% by weight, since otherwise there is the risk of polyester transfer onto the lacquer. The content of cyclohexanedimethanol is preferably <2% by weight, since this adversely affects the mechanical properties of the film. In a preferred embodiment the outer layers comprise <2% by weight, very particularly preferably <1.5% by weight, of monomers other than ethylene glycol and terephthalic acid, since there is the risk of swelling of the film surface during application of the lacquer when other monomers are used.

For the purposes of the invention it is preferable to use polyesters produced by the PTA (purified terephthalic acid) route, since the use of DMT (dimethyl terephthalate) polyesters generally results in the formation of more UV-active by-products, which are undesirable for the reasons mentioned. In a preferred embodiment, the polymer of the outer layers (especially the smooth outer layer) contains no calcium as transesterification catalyst and no antimony as polycondensation catalyst, since these tend to form large catalyst precipitates that, as particles themselves, can adversely affect the evenness of the applied lacquer and, if they occur in the particle-containing outer layer, can result in indentations in the smooth layer C. It is preferable that the two external layers (outer layer A and outer layer C) comprise polymers containing titanium compounds as polycondensation catalyst and magnesium compounds or manganese compounds as transesterification catalysts. In a particularly preferred embodiment, none of the layers contain a polymer with calcium as transesterification catalyst or antimony as polycondensation catalyst.

For the production of the film of the invention, the SV value of the polyester is expediently chosen such that the film has an SV value of >600, preferably >650 and ideally >700. The SV value of the film is here preferably <950 and more preferably <850. If the SV value is below 600, the film is so brittle that breaking often occurs even during production. Furthermore, the mechanical strength values mentioned hereinbelow are no longer reliably achieved when the SV value is lower. If the film has an SV higher than 950, the polymer in the extruder becomes so viscous that excessively high electric currents occur and pressure variations arise during extrusion. This results in poor reliability. In addition, there is an excessively high level of abrasion of extrusion dies and cutters.

The film must additionally have high transmittance in the 330 nm to 400 nm wavelength range. The transmittance is at every wavelength in the stated range greater than 50%, preferably greater than 60% and ideally greater than 72% (for procedure see measurement methods).

The higher the transparency in the UV range, the more rapidly and more completely UV curing of the lacquer through the film occurs. UV transparency is here both reduced by the total amount of particles introduced (see above) and influenced by the choice of polyester. Among polyethylene terephthalate raw materials, raw materials produced by the PTA route have proven superior here to those produced by the DMT route. Particularly unfavourable is the use of dimethyl naphthalate as monomer or the introduction of UV stabilizers or optical brighteners into the film.

In addition, yellow dyes reduce UV permeability. Yellow degradation products can also form during recycling of the polyester film. The proportion of recycled regrind material is therefore preferably less than 70% by weight, more preferably less than 60% by weight, especially less than 55% by weight, based on the total weight of the extrudate (polyester plus all additional substances) in all of the layers. The yellowness index YID of the film is preferably less than 3.0, more preferably <2.0 and ideally <1.8. These values can be achieved by using the particles and raw materials of the invention, even when up to 70% of recycled regrind material is supplied. If, for example, other materials are used, for example incompatible polymers such as particles of COC or polypropylene, polyurethane or barium sulfate, it is difficult or impossible to achieve said values.

Alongside the transparency in the UV range, the transparency of the film according to ASTM D1003 61 is in the visible wavelength range between 85% and 97%, preferably at least 89%, more preferably 90%, since this facilitates the inspection through the film of the substrate and of the applied lacquer. For the same reason, the haze is preferably <7%, more preferably <6% and especially <5%. Higher haze moreover impairs UV curing.

The transparency and haze of the invention are achieved through the selection of the particle material, particle size and particle content and also through the monomodality of the particle size distribution, as well as through choosing suitable polymers and the production process below.

For the use of the film of the invention in the application below, the roughness of the film is of particular importance. Roughness is here expressed by the smooth outer layer C having an Sa value of <10 nm, Sp<100 nm and Sv<100 nm, preferably Sa<8 nm, Sp<90 nm and Sv<60 nm, more preferably Sa<5 nm, Sp<70 nm and Sv<50 nm, and ideally Sa is less than 3 nm and Sp<60 nm and Sv<20. As a further parameter for describing the roughness, the total number of particles on the smooth outer layer C is <20, preferably <15 and more preferably <12. The lower the values for Sa, Sp and the total number of particles, the greater the evenness of the surface of the transferred lacquer and thus the higher the gloss.

The roughness values of the outer layer A provided with particles are Sa of at least 11 nm, Sp of at least 120 nm and Sv of at least 120 nm, preferably Sa is greater than or equal to 12 nm, Sp greater than or equal to 150 nm and Sv greater than or equal to 200 nm, more preferably Sa is greater than or equal to 14 nm, Sp greater than or equal to 200 nm and Sv greater than or equal to 220 nm. If the Sa value, Sp value and Sv value are below the stated preferred ranges, an adequate winding result is not achieved, i.e. wrinkles, longitudinal corrugations and other deformation effects occur, which can be transferred to the substrate. The higher the values, the better the winding result. If the roughness values Sa, Sp and Sv are greater than the maximum values, the particles press through into the smooth layer, which can result in the lacquer having inadequate surface quality. The lower these values, the better the optical properties of the transferred lacquer. The described roughness values are achieved through the use of the particles of the invention (in particular the particle size) and the particle content, through the distribution of the particles across the layers, see above, and through suitable polymers and the process below.

If the rough side is too rough, this results, as already mentioned above, in the roughness causing indentations in the lacquer to be transferred on the reverse side during winding. Therefore, the roughness values of the rough side must not be greater than Sa 40 nm, Sp<500 nm and Sv<800 nm, preferably Sa<25 nm, Sp<350 nm and Sv<500 nm.

In addition to the roughness, it has proven favourable for the lacquer quality when the gloss of the film (at 20°) is greater than 170 on both sides, especially greater than 180 and ideally greater than 190 on both sides. This desired range is achieved when the particles of the invention are used and the film is produced using polyester raw materials of the invention and in accordance with the process conditions of the invention.

In addition, the modulus of elasticity of the film of the invention is in both film directions (TD and MD) greater than 3000 N/mm², preferably greater than 3500 N/mm² and more preferably (in at least one film direction)>4000 N/mm² in the longitudinal and transverse directions. The F5 values (force at 5% elongation) are in the longitudinal and transverse directions preferably above 80 N/mm² and more preferably above 90 N/mm². These mechanical properties can be set and maintained by varying the parameters for the biaxial stretching of the film within the scope of the process conditions specified below.

When films having the stated mechanical properties are used under tension, they do not undergo excessive deformation, remain readily manageable and have a stiffness that is desired in the end use.

Production Process

The polyester polymers of the individual layers are produced by polycondensation, either starting from dicarboxylic acids and diol or—albeit less preferably—starting from the esters of the dicarboxylic acids, preferably the dimethyl esters, and diols. Polyesters that can be used preferably have SV values in the range from 500 to 1300; the individual values are of relatively little importance here, but the average SV value of the raw materials used must be greater than 700 and is preferably greater than 750. These values are expediently used to achieve the above-described SV values for the film. If the SV value is too low, the film will be brittle; if it is too high, the stretching forces in the process rise sharply, making economic production significantly more difficult.

The polymethylsilsesquioxane-based particles may already be added during production of the polyester. This is done by dispersing the particles in the diol, optionally milling, decanting and/or filtering, and adding to the reactor, either in the (trans)esterification step or the polycondensation step. This method is less preferred, since it is associated with significantly high production costs for the master batch by comparison with the process below.

Preference is given to producing a concentrated particle-containing polyester master batch using a gentle twin-screw extruder and diluting with particle-free polyester during film extrusion. This is the preferred method, since, by contrast with for example calcium carbonate particles (which have a tendency to form agglomerates with this method), agglomerates surprisingly do not occur when using the particles of the invention, which means it is possible to opt for the more economic method.

It has proven favourable here when no master batches containing less than 30% by weight of polyester are used. A further—albeit less preferred—option is to add the particles directly during film extrusion in a twin-screw extruder.

When a single-screw extruder is used, it has proven advantageous to predry the polyester. The drying step can be omitted if using a twin-screw extruder that has a degassing zone.

The polyester of the individual layers is first compressed and rendered flowable in extruders. In a preferred embodiment, the melt temperatures (temperature measured in the melt at the extruder outlet) are between 290° C. and 300° C. At temperatures above 300° C. the yellowness index increases; at temperatures below 290° C. there is an increased risk of unmelted polymer fractions, which can lead to undesirable surface elevations. This temperature is set via the ratio of the throughput to the speed of rotation of the extruder and/or via the temperatures of the extruder heating system. The conditions and temperatures depend in each case on the type of extruder used and can be set by those skilled in the art by means of the parameters mentioned. The melts are then formed in a coextrusion die into flat melt films, forced through a flat-film die, and drawn off on a chill roll and on one or more take-off rolls, wherein they cool and harden.

The film of the invention becomes biaxially oriented, i.e. biaxially stretched. The biaxial stretching of the film is most commonly carried out sequentially. It is preferable here that stretching is carried out first longitudinally (i.e. in machine direction=MD) and then transversely (i.e. perpendicularly to machine direction=TD). Longitudinal stretching can be carried out with the aid of two rolls running at different speeds in accordance with the desired stretching ratio. Transverse stretching is generally achieved using a suitable tenter frame. By choosing suitable stretching parameters, those skilled in the art can set the mechanical properties of the film such as modulus of elasticity, stiffness and extensibility.

The temperature at which stretching is carried out can vary within a relatively wide range and is guided by the desired properties of the film. The longitudinal stretching is generally carried out within a temperature range from 80° C. to 130° C. (heating temperatures 80° C. to 130° C.) and transverse stretching generally within a temperature range from 90° C. (start of stretching) to 140° C. (end of stretching). The longitudinal stretching ratio is within a range from 2.5:1 to 4.5:1, preferably from 2.8:1 to 4.0:1. A stretching ratio above 4.5 makes production significantly more problematic (film breaking). The transverse stretching ratio is generally within a range from 2.5:1 to 5.0:1, preferably from 3.2:1 to 4.0:1. In order to achieve the desired film properties, it has proven advantageous when the stretching temperature (in MD and TD) is below 125° C., and preferably below 118° C. Before transverse stretching, one or both surfaces of the film can undergo in-line-coating by processes known per se. The film is preferably uncoated on the unpigmented side and very particularly uncoated on both sides. With any coating there is a risk of contact-mediated transfer of coating or coating components to the lacquer and thus to the finished component. This is undesirable.

In the heat-setting that follows, the film is maintained under tension at a temperature of from 150° C. to 250° C. for a period of about 0.1 s to 10 s. The film is then wound in conventional manner.

Use

The films of the invention have excellent suitability as a process auxiliary film for the creation/transfer of smooth lacquer surfaces, especially when the lacquers are UV-cured. The lacquer is here applied to the film or to the component, application to the component being preferred. In this case, the film is then applied to the lacquer under tension with the smooth side; otherwise the film is applied to the component with the lacquer.

The components are preferably flat (with no great deformation). Deformation of the film during application must be avoided. The lacquer on the component is then cured through the film by UV irradiation. The film is then peeled off.

Analysis

The following values were measured in order to characterize the raw materials and the films:

Measurement of the Median Particle Diameter d₅₀

The diameter of the particles is determined using a Malvern MASTER SIZER® 2000. An average volume value dᵥ₅₀ is determined.

For this, isopropanol is added to the samples in a cuvette and this is then placed in the analyser. The dispersion undergoes laser analysis and the particle size distribution is determined from the signal by comparing with a calibration curve.

SEM or TEM measurements on the film produced using these particles give a median particle diameter that is on average 15-25% lower than that of the particles used. The diameter of the particles in the film can therefore be calculated from the diameters of the particles used to produce the film.

UV/Visible Spectra/Transmittance at Wavelength x

The films were measured in transmittance mode in a UV/visible twin-beam spectrometer (LAMBDA® 12 or 35) from Perkin Elmer USA. For this, a flat-sample holder is used to insert a film sample measuring about 3×5 cm into the measurement beam, perpendicularly to the beam path. The measurement beam passes via a 50 mm Ulbricht sphere to the detector, where the intensity is determined in order to determine the transparency at the desired wavelength.

The background material used is air. Transmittance at the desired wavelength is read.

Haze, Transparency

The test serves to determine the haze and transparency of plastic films for which optical clarity/haze is significant for the value in use. The measurement is performed in accordance with ASTM D1003 61 in a HAZE-GARD® XL 211 haze meter from Byk Gardner.

Gloss

The gloss is determined according to DIN 67530. The reflector value is measured as an optical parameter for the surface of a film. Based on the ASTM-D 523-78 and ISO 2813 standards, the angle of incidence is set at 20°. A light beam hits the flat test surface at the set angle of incidence and is reflected/scattered by it. The light rays striking the photoelectronic receiver are displayed as a proportional electrical quantity. The measured value has no dimensions and must be reported with the angle of incidence.

Yellowness Index

The yellowness index YID is the deviation from the colourless state in the “yellow” direction and is measured in accordance with DIN 6167.

K Value

The K value defines the force that is necessary to compress a particle by 10%. The measurement is performed using the Shimadzu MCT-W500 MICRO® Compression Testing Machine, based on JIS R1639-5. The K value is determined here at a test force of 19.60 mN and a loading rate of 0.892 mN/s.

SV (Standard Viscosity) Value

The standard viscosity SV (DCA) was measured, based on DIN 53 726, at a concentration of 1% in dichloroacetic acid in a Ubbelohde viscometer at 25° C. The SV value, which has no dimensions, is determined as follows from the relative viscosity (ηᵣₑₗ):

SV=(ηᵣₑₗ−1)×1000

For this, the film and the polymer raw materials were dissolved in DCA.

Mechanical Properties

The mechanical properties were determined via tensile testing based on DIN EN ISO 527-1 and -3 (type 2 test specimens) on film strips 100 mm×15 mm in size.

Visual Assessment of Surface Quality of the Smooth Side C after Winding

The film produced is stored on the wound customer roll for at least 5 days, and then 20 metres are unwound from the top of the roll and an area of at least 3 m² within the subsequent metres subjected to visual inspection. For this, the film is laid on a table with smooth surface such that the smooth film surface is facing away from the table. At least three analysts inspect said film surface under a high-power lamp at various angles between 10° and 90°. If this inspection reveals areas of unevenness in the film surface, these are marked and then analysed in an electron microscope. The number of elevations/depressions thus found is evaluated as number per m². The following evaluation grades are used here: very poor, poor, moderate and good. Very poor means 20 elevations and depressions per m², poor means 10 elevations and depressions per m², moderate means 5 elevations and depressions per m² and good means <5 elevations and depressions per m².

Roughness Values Sa, Sp and Sv

The topography of the surface is determined using a PROFILM3D® white light interferometry microscope from KLA Corporation, Milpitas, Calif., USA using the PROFILM® measurement software version 4.0.6.3, in accordance with ISO 16610-19 (ripple filtering) and ISO 25178-2 (roughness parameters). An area of 0.84 mm×1.13 mm (484×648 pixels) is measured with the 10× Nikon CF IC EPI PLAN® DI lens and 2×software magnification (zoom).

For the measurement, a piece of film 25×100 mm in size is clamped between two metal rings with a diameter of 4 cm so that no rippling in the film sample can be seen visually.

The measurement is performed in PSI mode (Phase Shifting Interferometry). All measurement parameters are set to the default values supplied with the software. The measurement length in the direction of thickness of the film is 8 μm (Backscan=3 μm, Scan Length=5 μm). Under these standard measurement conditions, the proportion of undetected pixels is less than 10%. Missing measured values are computed from surrounding pixels (Fill In Invalids). A polynomial of degree 3 is used to correct any inclination of the surface (Flatten).

All S parameters in the sequence are calculated from the S-F surface. Sa is the arithmetic mean of the absolute ordinate values within the defined range (A):

$$Sa = \frac{1}{A} {\int \int }_{A} \vert z ( x , y ) \vert dx dy$$

Sp and Sv denote the maximum peak height and maximum pit height within the defined range. The calculation rules for the parameters Sa, Sp and Sv are stated in the standard ISO 25178-2.

The Sa, Sp and Sv values for a sample are average values of 5 different measurement points selected at random.

In addition, the parameter Total Number (Number of Particles/Grains; total number of particles) is used to characterize the surface according to the particle cutoff (Particles/Grains) described in the standard ISO 25178-2 and implemented in the PROFILM® measurement software version 4.0.6.3 with a threshold value (Threshold) of 20 nm.

### EXAMPLES

Inventive example 1 and Comparative Examples 1-3 The polymer mixtures are melted at 292° C. and, after passing through a flat-film die, applied electrostatically to a chill roll temperature-controlled at 50° C. They are then subjected to longitudinal stretching, followed by transverse stretching, under the following conditions:

| | | | |
|---|---|---|---|
| Longitudinal | Heating temperature | 75-115 | ° C. |
| stretching | | | |
| | Stretching temperature | 115 | ° C. |
| | Longitudinal stretching | 3.8 | |
| | ratio | | |
| Transverse | Heating temperature | 100 | ° C. |
| stretching | | | |
| | Stretching temperature | 112 | ° C. |
| | Transverse stretching | 3.8 | |
| | (including stretching | | |
| | in 1st setting field) | | |
| Setting | Temperature | 237-150 | ° C. |
| | Duration | 3 | s |
| Setting | Temperature of 1st | 170 | ° C. |
| | setting field | | |

The following raw materials are used in the examples:

PET1=polyethylene terephthalate raw material produced from ethylene glycol and terephthalic acid, having a SV value 820.

PET2=polyethylene terephthalate raw material produced from ethylene glycol and terephthalic acid, having a SV value 790. The raw material comprises 1% by weight of vaterite calcium carbonate from the manufacturer Maruo, surface-treated as described in patent EP A 0 460 640 (whose Unites equivalent is U.S. Pat. No. 5,164,439 which is hereby incorporated by reference herein in its entirety) wherein 50% of the particles are within a size range of ±0.2 μm of the particle diameter of 1.0 μm. The calcium carbonate particle is by definition not crosslinked (salt) and does not contain any CnH2n+x units in the basic particle structure. The K value is >32.

PET3=polyethylene naphthalate raw material produced from ethylene glycol and naphthalene-1,6-dicarboxylic acid.

PET4=polyethylene terephthalate raw material having an SV value of 710 and containing 25 mol % of isophthalic acid as comonomer.

PET5=polyethylene terephthalate raw material produced from ethylene glycol and terephthalic acid, having a SV value 790. The raw material comprises 5% by weight of PMSQ (E+508 from Coating Products) wherein 65% of the particles are within a size range of ±0.2 μm of the particle diameter of 0.8 μm. The PMSQ particles are covalently crosslinked via Si—O bonds and in addition have numerous CH3 groups (formula CₙH2ₙ₊ₓ, where n=1 and x=1). The K value of the particles is 15.1.

Table 1 below summarizes the formulations and resulting film properties:

| | | Example 1 | CE1 | CE2 | CE3 |
|---|---|---|---|---|---|
| Layer | Film | 75 | 75 | 75 | 75 |
| | thickness | | | | |
| | [μm] | | | | |
| | Thickness | 2.5 | 2.5 | 2.5 | 2.5 |
| | A [μm] | | | | |
| | Thickness | 65.7 | 65.7 | 65.7 | 65.7 |
| | B [μm] | | | | |
| | Thickness | 6.8 | 6.8 | 6.8 | 6.8 |
| | C [μm] | | | | |
| Layer A | PET 1 [%] | 95 | 60 | 95 | 95 |
| | PET 2 [%] | | 40 | | |
| | PET 3 [%] | | | | |
| | PET 4 [%] | | | | |
| | PET 5 [%] | 5 | | 5 | 5 |
| Layer B | PET 1 [%] | 60 | 60 | 50 | 60 |
| | PET 2 [%] | | | | |
| | PET 3 [%] | | | 10 | |
| | PET 4 [%] | | | | |
| | PET 5 [%] | | | | |
| | Self-regrind | 40 | 40 | 40 | 40 |
| | [%] | | | | |
| Layer C | PET 1 [%] | 100 | 100 | 100 | 120 |
| | PET 2 [%] | | | | |
| | PET 3 [%] | | | | |
| | PET 4 [%] | | | | 80 |
| | PET 5 [%] | | | | |
| Transparency | in % | 90 | 91 | 90.5 | 91.5 |
| Haze | in % | 4.5 | 3.5 | 4.4 | 4.4 |
| Gloss (20°) | Layer C/ | 201/200 | 203/182 | 202/199 | 200/195 |
| | layer A | | | | |
| Yellowness | | 1.7 | 1.6 | 1.8 | 1.7 |
| index YID | | | | | |
| Modulus of | N/mm² | 4000 | 3900 | 4100 | 4050 |
| elasticity MD | | | | | |
| Modulus of | N/mm² | 5400 | 5300 | 5320 | 5450 |
| elasticity MD | | | | | |
| F5 MD | N/mm² | 200 | 195 | 206 | 205 |
| F5 TD | N/mm² | 275 | 260 | 267 | 270 |
| Transmittance | in % | 75 | 76 | 8 | 78 |
| at 353 nm | | | | | |
| Roughness | in nm | 16 | 15 | 16 | 17 |
| Sa of outer | | | | | |
| layer (A) | | | | | |
| Roughness | in nm | 250 | 260 | 248 | 245 |
| Sp of outer | | | | | |
| layer (A) | | | | | |
| Roughness | in nm | 2 | 1.7 | 2 | 2.1 |
| Sa of outer | | | | | |
| layer (C) | | | | | |
| Roughness | in nm | 35 | 40 | 37 | 38 |
| Sp of outer | | | | | |
| layer (C) | | | | | |
| Visual | | Good | Good-moderate | Good | Good |
| assessment | | | | | |
| Winding | | good | Good | Good | Good |
| result | | | | | |
| Note | | No abraded | Abraded material | As a result of | Polyester was |
| | | material detected | detected during | the low UV | found on the |
| | | during further | further processing, | permeability, | lacquer during |
| | | processing. | which was shown | UV-curing of the | further processing, |
| | | | by analyses to | applied lacquer | this having |
| | | | consist of | through the film | undergone transfer |
| | | | polyester and | was unsuccessful. | from the smooth |
| | | | calcium carbonate | | side on account |
| | | | (mainly calcium | | of the lower |
| | | | carbonate) and | | crystallinity. |
| | | | had resulted in | | |
| | | | indentations in the | | |
| | | | lacquer. Visual | | |
| | | | assessment of the | | |
| | | | film alone | | |
| | | | revealed more | | |
| | | | elevations than | | |
| | | | in example 1. | | |

That which is claimed:

1. An at least three-layer biaxially oriented polyester film comprising at least a base layer B, a rough outer layer A and a smooth outer layer C,
wherein the outer layers A and C are each external layers and are arranged on the opposite surfaces of the base layer B;
the outer layer A comprises polymethylsilsesquioxane-based particles, the outer layer C comprises less than 0.1% by weight of particles different from the polymethylsilsesquioxane-based particles in outer layer A (the percentages by weight being based on the mass of the respective layer);
the polyester in all of the layers of the at least three-layer polyester film contains no 2,6-naphthalenedicarboxylic-acid-derived units as repeat unit;
the film overall comprises less than 0.1% by weight (based on the mass of the film overall) of particles;
the polyesters in the outer layers of the film comprise isophthalic acid-derived repeat units in an amount of <19% by weight (based on the mass of the respective outer layer).

2. The polyester film according to claim 1, wherein the outer layer A comprises polymethylsilsesquioxane-based particles in an amount of 0.1% by weight to 0.7% by weight (based on the total amount of outer layer A).

3. The polyester film according to claim 1, wherein the outer layer A comprises polymethylsilsesquioxane-based particles in an amount of 0.2% by weight to 0.35% by weight (based on the total amount of outer layer A).

4. The polyester film according to claim 1, wherein the polymethylsilsesquioxane-based particles have an average diameter d₅₀ of 0.5 μm to 1.5 μm.

5. The polyester film according to claim 1, wherein the polymethylsilsesquioxane-based particles have an average diameter d₅₀ of 0.6 μm to 1.2 μm.

6. The polyester film according to claim 1, wherein the polymethylsilsesquioxane-based particles have an average diameter d₅₀ of 0.65 μm to 1.0 μm.

7. The polyester film according to claim 1, wherein the polymethylsilsesquioxane-based particles comprise covalently linked units of the formula CₙH₂ₙ₊ₓ where 0<n<10 and x=0 or 1.

8. The polyester film according to claim 1, wherein the film comprises particles composed of incompatible polymers to an extent of less than 0.1% by weight (based on the mass of the film overall).

9. The polyester film according to claim 1, wherein the film comprises particles composed of incompatible polymers to an extent of 0% by weight (based on the mass of the film overall).

10. The polyester film according to claim 1, wherein the film comprises titanium dioxide particles and barium sulfate particles to an extent of less than 0.05% by weight (based on the mass of the film overall).

11. The polyester film according to claim 1, wherein the film comprises titanium dioxide particles and barium sulfate particles to an extent of 0.03% by weight (based on the mass of the film overall).

12. The polyester film according to claim 1, wherein the film comprises titanium dioxide particles and barium sulfate particles to an extent of 0% by weight (based on the mass of the film overall).

13. The polyester film according to claim 1, wherein the film comprises particles composed of calcium carbonate and/or silicon dioxide and/or aluminium trioxide to an extent of less than 0.05% by weight (based on the mass of the film overall).

14. The polyester film according to claim 1, wherein the film comprises particles composed of calcium carbonate and/or silicon dioxide and/or aluminium trioxide to an extent of less than 0.03% by weight (based on the mass of the film overall).

15. The polyester film according to claim 1, wherein the film comprises particles composed of calcium carbonate and/or silicon dioxide and/or aluminium trioxide to an extent of less than 0.01% by weight (based on the mass of the film overall).

16. The polyester film according to claim 1, wherein the total film thickness is at least 12 μm to at most 90 μm.

17. The polyester film according to claim 1, wherein the total film thickness is at least 23 μm to at most 80 μm.

18. The polyester film according to claim 1, wherein the total film thickness is at least 35 μm to at most 76 μm.

19. The polyester film according to claim 1, wherein the thickness of outer layer A is at least 0.8 μm to at most 3.7 μm.

20. The polyester film according to claim 1, wherein the thickness of outer layer A is at least 1.0 μm to at most 3.5 μm.

21. The polyester film according to claim 1, wherein the thickness of outer layer A is at least 1.4 μm to at most 3.0 μm.

22. The polyester film according to claim 1, wherein the thickness of outer layer C is at least 2 μm.

23. The polyester film according to claim 1, wherein the thickness of outer layer C is at least 2.5 μm.

24. The polyester film according to claim 1, wherein the thickness of outer layer C is at least 3 μm to at most 8.0 μm.

25. The polyester film according to claim 1, wherein the polyesters used for production of the outer layers of the film comprise isophthalic acid-derived repeat units in an amount of <15% by weight (based on the mass of the respective outer layer) and the proportion of cyclohexanedimethanol-derived repeat units in the polyesters in the film overall is <2% by weight (based on the mass of the film overall).

26. The polyester film according to claim 1, wherein the polyesters used for production of the outer layers of the film comprise isophthalic acid-derived repeat units in an amount of <10% by weight (based on the mass of the respective outer layer) and the proportion of cyclohexanedimethanol-derived repeat units in the polyesters in the film overall is <2% by weight (based on the mass of the film overall).

27. The polyester film according to claim 1, wherein the outer layer C comprises only particles that potentially arise as catalyst residues during the production of the polyester used.

28. An at least three-layer biaxially oriented polyester film comprising at least a base layer B, a rough outer layer A and a smooth outer layer C,
wherein the outer layers A and C are each external layers and are arranged on the opposite surfaces of the base layer B,
and wherein the film has the following properties:
transparency of 85 to 97%;
haze of <7%;
a total film thickness of 12-90 μm;
a smooth outer layer C having the roughness values Sa<10 nm, Sp<100 nm, Sv<100 nm, and a total number of particles of <20, measured according to ISO 25178-2;
a smooth outer layer C that comprises less than 0.1% by weight of particles different from the polymethylsilsesquioxane-based particles in outer layer A;
a smooth outer layer C having a thickness of at least 2 μm;
a rough outer layer A having the roughness values Sa≥11 nm, Sp≥120 nm, Sv≥120;
where the rough outer layer A comprises polymethylsilsesquioxane-based particles having an average size d₅₀ of 0.5 μm to 1.5 μm and a particle content of 0.1% to 0.7% by weight.

29. A process for producing a polyester film according to claim 1 comprising
compressing and rendering fowable the polyester or polyester blend of the individual layers in extruders;
forming the melts in a coextrusion die into a flat melt film that is then drawn off as a prefilm on a chill roll and on one or more take-off rolls;
cooling and hardening the prefilm; and then biaxially
orienting the hardened prefilm,
wherein the outer layers A and C are each external layers and are arranged on the opposite surfaces of the base layer B, the outer layer A comprises polymethylsilsesquioxane-based particles, the outer layer C comprises less than 0.1% by weight of particles different from the polymethylsilsesquioxane-based particles in outer layer A (the percentages by weight being based on the mass of the respective layer) and
the polyester in all of the layers of the at least three-layer polyester film contains no 2,6-naphthalenedicarboxylic-acid-derived units as repeat unit,
the film overall comprises less than 0.1% by weight (based on the mass of the film overall) of particles, and
the polyesters in the outer layers of the film comprise isophthalic acid-derived repeat units in an amount of <19% by weight (based on the mass of the respective outer layer).

30. A lacquer surface process film comprising a film as claimed in claim 1, wherein said film is either a lacquer surface creation film or a lacquer surface transfer film.
